(19) United States
(12) Patent Application Publication
(10) Pub. No.: US 2017/0076417 A1
(43) Pub. Date: Mar. 16, 2017

(54) DISPLAY FRAME BUFFER COMPRESSION

(71) Applicant: Apple Inc., Cupertino, CA (US)

(72) Inventor: Eran Tamari, Herzliya Pituach (IL)

(21) Appl. No.: 14/850,553

(22) Filed: Sep. 10, 2015

(51) Int. Cl. G06T 1/20; G06T 15/00; G06T 1/60

(52) U.S. Cl. CPC G06T 1/20; G06T 1/60; G06T 15/005

(57) ABSTRACT

Techniques are disclosed relating to rendering display frames. In one embodiment, an integrated circuit is disclosed that includes display pipeline circuitry configured to produce, for a display device, a sequence of frames that includes a first frame and a second, subsequent frame. The display pipeline circuitry is configured to identify pixels of the second frame that differ from pixels of the first frame, and to transmit, to the display device, both the content of identified, differing pixels and a bitmap. In such an embodiment, the bitmap indicates which pixels of the second frame differ from pixels of the first frame. In some embodiments, the display pipeline circuitry includes a comparator circuit configured to generate the bitmap by comparing the pixels of the second frame with the pixels of the first frame.

### BACKGROUND

Technical Field

This disclosure relates generally to processors, and, more specifically, to processors that include a display pipeline for generating image frames.

Description of the Related Art

Many computing devices include a display pipeline for generating frames that are presented on a display. A display pipeline typically retrieves image information from memory and processes the information in various pipeline stages to eventually produce frames, which are communicated to the display. In some implementations, various pipeline stages are implemented using dedicated circuitry such as a graphics processing unit (GPU). These stages may, for example, create a three-dimensional model of a scene and produce a two-dimensional raster representation of the scene, lighting, texturing, clipping, shading stages, etc. In some implementations, other pipeline stages may take two-dimensional image information and format it for particular characteristics of the display. For example, such stages may gather image information from multiple sources, crop the image, adjust the color space to one supported by the display (e.g., RGB to YCbCr), adjust the lighting, etc. In many instances, a display pipeline can consume considerable amounts of power.

### SUMMARY

The present disclosure describes embodiments in which an integrated circuit includes display pipeline circuitry configured to generate frames for a display. In one embodiment, the display pipeline circuitry is configured to compare successive frames in a sequence of frames in order to identify pixels of one frame that differ from pixels of another frame. The display pipeline circuitry, in this embodiment, is configured to transmit, to the display device, content for the differing pixels (e.g., red green blue (RGB) pixel values) and a corresponding bitmap that indicates which pixels differ between the frames. In some embodiments, the display pipeline circuitry generates the bitmap by using a frame buffer and a comparator circuit. In such an embodiment, the frame buffer stores pixel content of a previous frame until the content can be retrieved by the comparator circuit for comparison against pixel content of a subsequent frame.

In one embodiment, a display includes a controller configured to assemble a given frame from pixel content stored from a previous frame and the received content of the differing pixels. In such an embodiment, the controller determines to use pixels from the previous frame based on the bitmap indicating whether those pixels are the same for the given frame. In some embodiments, the controller uses the bitmap to determine which pixel content to retrieve from a frame buffer that stores the pixel content from the previous frame.

### BRIEF DESCRIPTION OF THE DRAWINGS

FIG. 1 is a block diagram illustrating one embodiment of a computing device with a display pipeline for a display.

FIG. 2 is a block diagram illustrating one embodiment of a compression unit in the display pipeline.

FIG. 3 is a block diagram illustrating one embodiment of a controller in the display.

FIG. 4 is a block diagram illustrating one embodiment of an exemplarily pixel transmission.

FIGS. 5A and 5B are flowcharts illustrating embodiments of methods performed by a computing device having a display pipeline or a display device.

FIG. 6 is a block diagram illustrating one embodiment of an exemplary computing device.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “display pipeline circuitry configured to produce a sequence of frames” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. §112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically indicated. For example, in a display pipeline having eight processing stages, the terms “first” and “second” stage can be used to refer to any two of the eight stages. In other words, the “first” and “second” stages are not limited to the initial two stages.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

The present disclosure recognizes that successive frames being communicated to a display may often include a substantial amount of identical content. For example, if the frames correspond to a video of a person moving against a static background, each frame may include the same pixels for the static background. Communicating these redundant pixels for each frame can result in a significant amount of unnecessary data being transmitted. This redundant transmission can be wasteful in devices with power constraints (e.g., devices that operate on a battery power supply).

As will be described below, in various embodiments, a display pipeline is configured to compare frames being provided to a display in order to identify which pixels differ from one frame to the next. In various embodiments, the display pipeline transmits merely content for the differing pixels of a frame (as opposed to the content of all the pixels in the frame) and send a corresponding bitmap that indicates which pixels differ from the previously transmitted frame. The term “bitmap” has its ordinary and accepted meaning in the art, which includes a data structure that maps items in one domain to one or more bits. For example, as will be described below, a bitmap may map pixel locations in a frame to corresponding bits, which indicate whether pixels at those locations are present in a previous frame. A display controller may then assemble a frame from the received differing pixels and pixels stored from the previous frame as indicated from the received bitmap.

In some embodiments, when a sequence of pixels is transmitted, the display pipeline is configured to masquerade the bitmap as an initial pixel in the sequence in order to comply with display specifications for communicating pixels over an interconnect with a display. That is, a display specification may be used that supports communicating pixels, but does not support communicating a bitmap. In such an embodiment, the display pipeline may communicate the bitmap as an initial pixel such that the bitmap would appear as a pixel from the perspective of one monitoring traffic being communicated over the interconnect from the pipeline to the display controller. In such an embodiment, the display controller, however, is aware that the initial pixel is not a pixel, but rather the bitmap, and is able to recover the bitmap. The controller may thus determine from this “initial pixel,” which is the bitmap, what pixels will be subsequently received for an incoming frame.

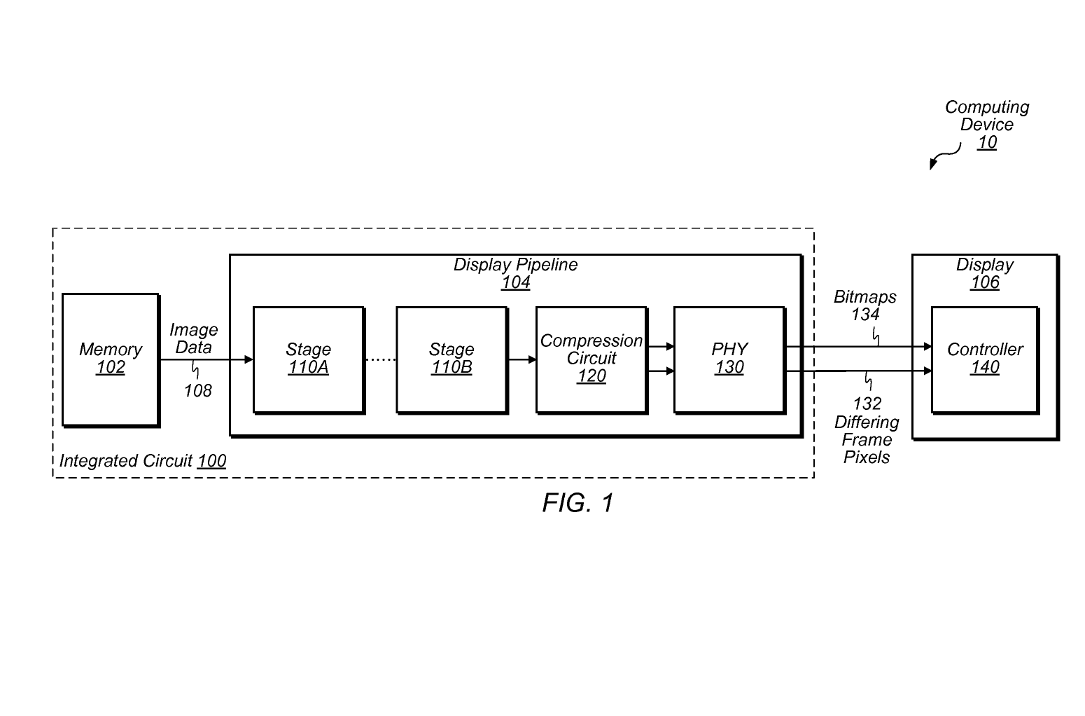

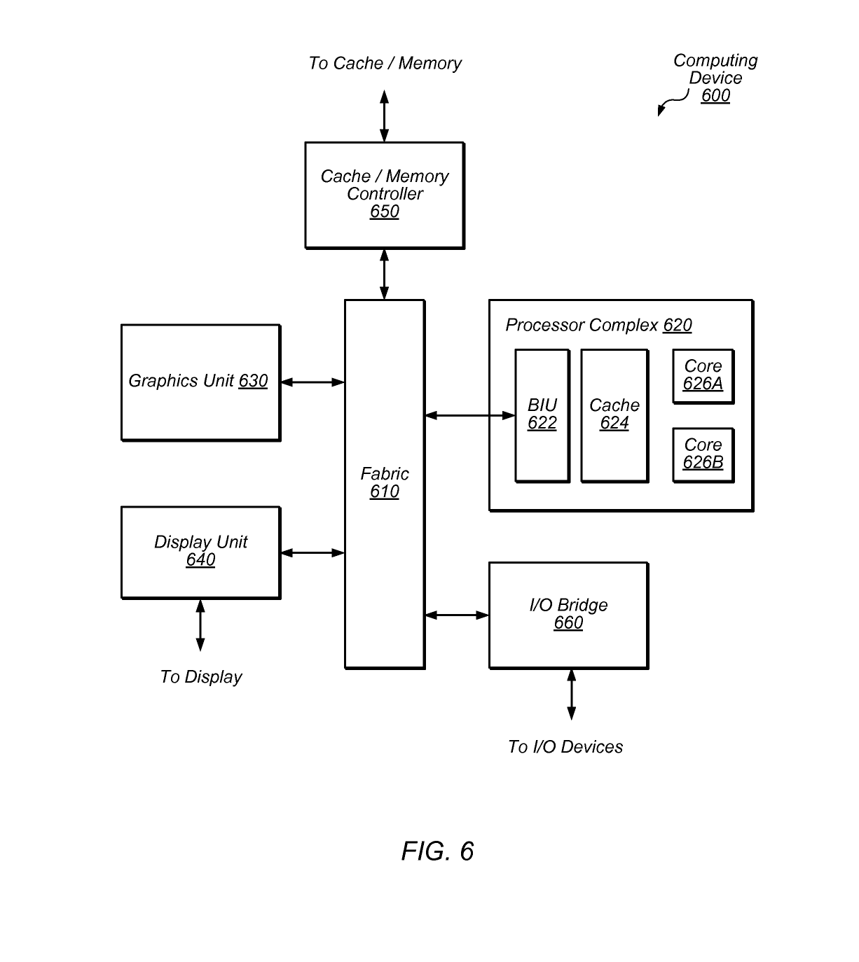

Turning now to FIG. 1, a block diagram of a computing device 10 is depicted. In the illustrated embodiment, computing device 10 includes an integrated circuit 100 coupled to a display 106. As shown, integrated circuit 100 includes a memory 102 and a display pipeline 104, which, in turn, includes multiple pipeline stages 110A-110B, a compression unit 120, and a physical interface (PHY) 130. Display 106 also includes a display controller 140. In various embodiments, computing device 10 may be implemented differently than shown in FIG. 1. Accordingly, in some embodiment, memory 102 and display pipeline 104 may be located in separate integrated circuits. Computing device may also include additional elements such as those described below with respect to FIG. 6.

Display pipeline 104, in one embodiment, is circuitry that is configured to retrieve image data 108 from memory 102 and generate corresponding frames for presentation on display 106. (In one embodiment, memory 102 may be random access memory (RAM); however, in other embodiments, memory 102 may be other suitable forms of memory such as those discussed below with respect to FIG. 6.) In various embodiments, display pipeline 104 processes image data 108 in one or more pipeline stages 110 in order to produce frames for display 106. These stages 110 may perform a variety of operations in various embodiments, for example, image scaling, image rotation, color space conversion, gamma adjustment, ambient adaptive pixel modification (adjusting pixels based on an amount of detected ambient light), white point correction, layout compensation, panel response correction, dithering, etc. Although display pipeline 104 only shows two stages 110A and 110B (referred to collectively as stage 110 or stages 110), display pipeline may have more stages 110. In some embodiments, display pipeline 104 may implement stages of a graphics processing unit (GPU) such as modeling, lighting, texturing, clipping, shading, etc. In another embodiment, computing device 10 may include a GPU separate from display pipeline 104.

Display 106, in the illustrated embodiment, is a device configured to display frames on a screen. Display 106 may implement any suitable type of display technology such as liquid crystal display (LCD), light emitting diode (LED), organic LED (OLED), digital light processing (DLP), cathode ray tube (CRT), etc. In some embodiments, display 106 may include a touch-sensitive screen. In the illustrated embodiment, operation of display 106 is managed by display controller 140. In various embodiments, controller 140 may include dedicated circuitry, a processor, and/or a memory having firmware executable by the processor to control display 106. As will be discussed below, display controller 140 may be configured to receive frame information and coordinate display of the frames on a screen of display 106.

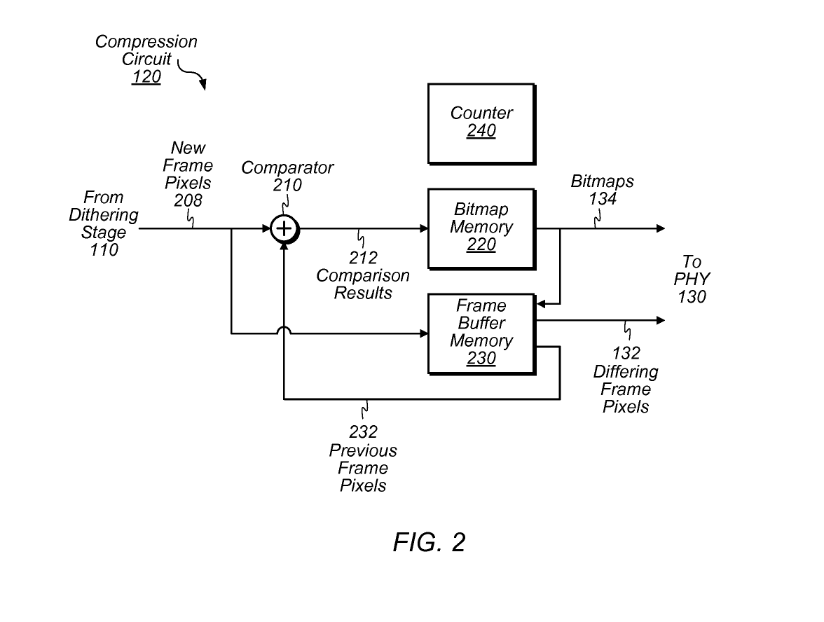

Compression circuit 120, in one embodiment, is configured to identify differing pixels 132 between successive frames and cause PHY 130 to communicate only the differing frame pixels 132 to display 106. Accordingly, circuit 120 is thus described as a “compression” circuit because, in many instances, it may significantly reduce the number of pixels communicated to display 106 if successive frames have substantial overlapping content. In such an embodiment, compression circuit 120 also sends bitmaps 134 to controller 140 in order indicate which of the pixels differ from one frame to the next frame. Bitmaps 134 may identify differing pixels between frames using any of various techniques; however, in various embodiments, bitmaps 134 may be distinct from pixels 132—i.e., a bitmap 134 does not include the pixels 132 to which it corresponds. In some embodiments, compression circuit 120 may create multiple bitmaps 134 for a given frame being communicated to display 106. Accordingly, in some embodiments, each bitmap 134 may correspond to a line within a frame (or a portion of a line, in some embodiments). As will be described below with respect to FIG. 2, in various embodiments, compression circuit 120 may include circuitry to store previous frame pixels and to compare this pixel data with pixels of new frames being created by pipeline 104.

PHY 130, in one embodiment, is circuitry configured to handle the physical layer interfacing of display pipeline 104 with display 106. Accordingly, PHY 130 may include circuitry that drives signals for communicating content of pixels 132 and bitmaps 134 across an interconnect (e.g., a bus) coupling pipeline 104 to display 106. In some embodiments, PHY 130 may communicate data to display 106 in a manner that is compliant with one or more specifications defined by a standards body or other entity. For example, in some embodiments, PHY 130 implements a display-PHY (D-PHY) for a display serial interface (DSI) in compliance with a specification of the Mobile Industry Processor Interface (MIPI) Alliance (i.e., PHY 130 may support MIPI DSI, where pixels 132 and bitmaps 134 may be communicated using MIPI high speed (HS) transfers). PHY 130 may also support additional specifications such as, but not limited to, DisplayPort or embedded DisplayPort, High-Definition Multimedia Interface (HDMI), etc.

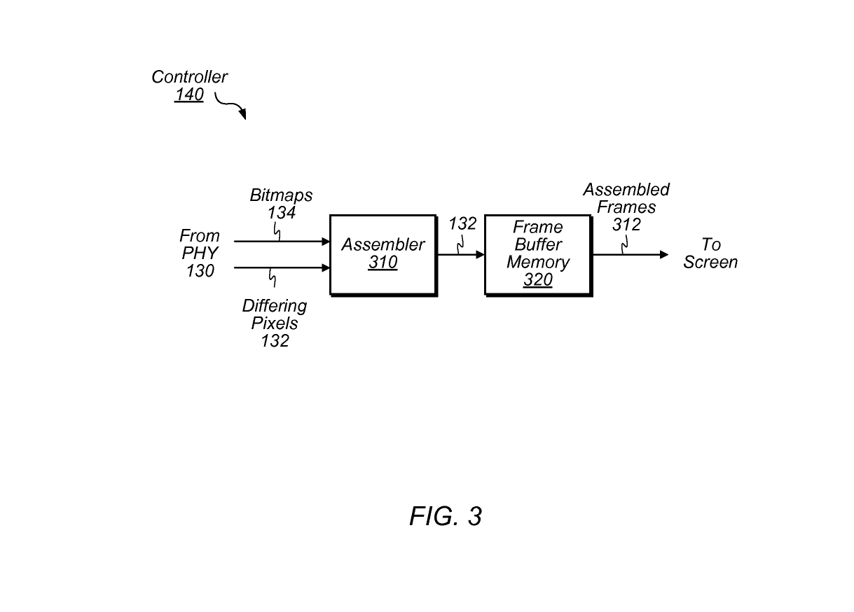

Controller 140, in one embodiment, includes circuitry configured to receive content of pixels 132 and, based on bitmaps 134, assemble pixels 132 into frames that are presented on display 106. As will be described below with respect to FIG. 3, in various embodiments, controller 140 includes a memory configured to store pixels from a previously received frame, which can be combined with differing frame pixels 132. Controller 140 may also include logic that uses bitmaps 134 to identify which pixel should be retrieved from this memory when assembling a frame.

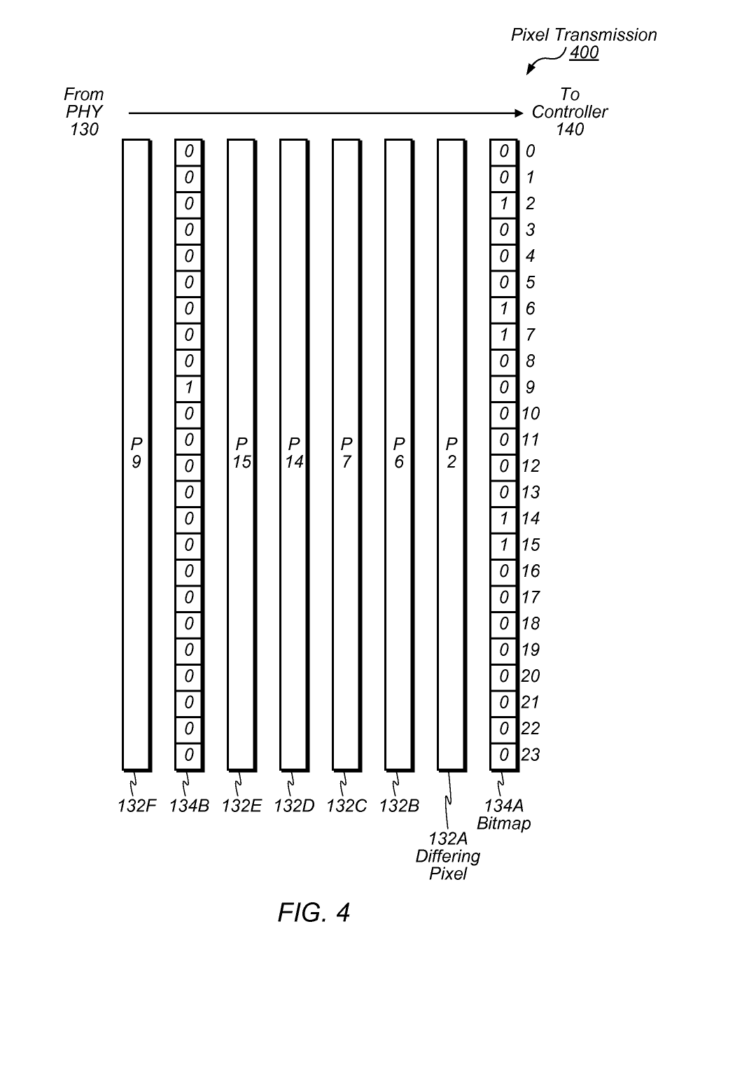

As will be described below with respect to FIG. 4, in some embodiments, display pipeline 104 (or more specifically compression circuit 120 and PHY 130) is configured to masquerade a bitmap 134 as an initial pixel (or a pixel at some other location known to controller 140 such as the last pixel in a sequence). That is, from the perspective of one monitoring the traffic across the interconnect between PHY 130 and display 106, bitmap 134 would appear to be a pixel being communicated to display 106. Accordingly, in some embodiments, bitmap 134 may have the same number of bits as a differing pixel 132. In some embodiments, bitmap 134 may be included within the same type of packet used to communicate pixels over the interconnect with display 106. In doing so, PHY 130 may be able to communicate pixels in a manner that is compliant with a display specification that does not support the ability to communicate merely differing pixels (e.g., MIPI DSI).

Turning now to FIG. 2, a block diagram of one embodiment of compression circuit 120 is depicted. In the illustrated embodiment, compression circuit 120 includes a comparator 210, bitmap memory 220, frame buffer memory 230, and a counter 240. In other embodiments, compression circuit 120 may be configured differently than shown.

Comparator 210, in one embodiment, is circuitry configured to compare pixels of a previously frame (previous frame pixels 232) with pixels of new frame (new frame pixels 208), which are about to be transmitted to display 106 via PHY 130. In the illustrated embodiment, comparator 210 receives pixels 208 from a dither stage 110 that applies dithering operations to frames. In such an embodiment, comparator 210 may be directly coupled to an output of the dithering stage. In other embodiments, however, comparator 210 may receive pixels 208 from a different pipeline stage 110. In one embodiment, comparator 210 compares pixels 208 and 232 by performing exclusive-OR (XOR) operations on the pixels. Accordingly, comparator 210 may include multiple XOR gates, each configured to compare one bit of a pixel 132, and an OR gate coupled to the output of the XOR gates. Comparator 210 may then indicate the results shown as comparison results 212. In some embodiments, comparison results 212 may include a respective bit for each comparison that indicates whether a match of pixels was determined. In other embodiments, comparison results 212 may indicated differently—e.g., results 212 may be a value indicating the locations of matching (or differing) pixels within a frame.

Bitmap memory 220, in one embodiment, is a memory configured to aggregate comparison results 212 in order to create bitmaps 134 from the results 212. Bitmap memory 220 may then continue to maintain a bitmap 134 until it can be communicated to PHY 130 for transmission with the corresponding differing frame pixels 132. In one embodiment, memory 220 (and/or memory 230) is implemented using a static random access memory (SRAM); however, in other embodiments, other types of memory may be used.

Frame buffer memory 230, in one embodiment, is a memory configured to store pixels for an entire frame that is being transmitted to display 106 so that its pixels 232 (e.g., the previous frame) can be compared against pixels 208 of a new, incoming frame. In some embodiments, however, these roles may be handled by separate memories. In some embodiments, memory 230 (or more generally compression circuit 120) may identify which of the stored pixels to send as differing frame pixels 132 based on bitmaps 134 stored in bitmap memory 220. In other embodiments, memory 230 may include an additional bit of storage for each pixel in order to indicate whether that pixel should be sent. In the illustrated embodiment, memory 230 also selects which pixels to send to PHY 130 and comparator 210 based on a value of counter 240.

Counter 240, in one embodiment, is a circuit configured to maintain a value identifying the last transmitted pixel to PHY 130. In other embodiments, however, counter 240 may maintain a different value such as one that tracks the next pixel to be sent, the last pixel used in a comparison, and/or the next pixel to be compared. In some embodiments, compression circuit 120 may use multiple counters 240 to track multiple metrics used to determine which pixels should be sent to PHY 130 and comparator 210.

Turning now to FIG. 3, a block diagram of display controller 140 is depicted. As noted above, in various embodiments, display controller 140 is configured to assemble frames from received differing frame pixels 132 and previously stored pixels for an earlier frame based on bitmaps 134. In the illustrated embodiment, controller 140 includes an assembler 310 and a frame buffer memory 320. In other embodiments, controller 140 may be configured differently than shown. Accordingly, in various embodiments, controller 140 includes additional circuitry located between assembler 310 and frame buffer memory 320 and/or between memory 320 and the screen of display 106.

Assembler 310, in one embodiment, is logic configured to assemble frames 312 based on bitmaps 134. In such an embodiment, assembler 310 may use a bitmap 134 to identify what pixels 132 are being received (e.g., where the pixels should located within a frame). Assembler 310 may then write 132 the pixels to the appropriate locations in memory 320 such that the assembled frame 312 includes both pixels from the previous frame 312 and new differing pixels 132. Accordingly, in one embodiment, assembler 310 includes logic that is generates a write request to memory 320 for pixels 132 in response to a bitmap 134 indicating that the pixels are present in transmission of pixels 132 (and thus were not present in the previous frame). In such an embodiment, assembler 310 may include a counter that is combined with the location of a bit in bitmap in order to determine the pixel location in the frame where the pixel is to be stored.

Frame buffer memory 320, in one embodiment, is a memory configured to store pixels of assembled frames 312. In various embodiments, the screen is configured to retrieve lines of pixels from memory 320 and then display them. In some embodiments, memory 320 is an SRAM.

Turning now to FIG. 4, a block diagram illustrating one embodiment of a pixel transmission 400 is depicted. As shown, transmission 400 may include bitmaps 134 and corresponding pixels 132. In the illustrated embodiment, each bitmap 134 precedes the pixels 132 to which it pertains. In other embodiments, a different ordering of bitmaps and pixels may be used.

In some embodiments, a bitmap 134 pertains to a block of pixels and includes an indication for each pixel in the block that indicates whether that pixel differs from the preceding frame. In the illustrated embodiment, bitmap 134 includes a bit for each pixel in the block, which indicates whether the pixel differs. For example, the bit at position 0 is not set (i.e., it has the value 0) indicating that the pixel at position 0 is the same in the preceding frame, and thus, has not been included in transmission 400. The bit at position 2, however, is set (i.e., it has the value 1) indicating that it differs from the preceding frame. Thus, transmission 400 includes pixel 132A corresponding to position 2 in the block. Accordingly, bitmap 134A also includes set bits at positions for 6, 7, 14, and 15 indicating that those pixels 132B-132E differ, and thus, are included in transmission 400. In the next block, only a pixel 132F differs, so bitmap 134B includes a set bit at position 9 for the location of pixel 132F in the block corresponding to bitmap 134.

As noted above, in some embodiments, a bitmap 134 may be masqueraded as a pixel when being transmitted. Accordingly, in the illustrated embodiment, bitmap 134A includes 24 bits because, in some embodiments, pixels 132 are 24-bit red-green-blue (RGB) pixels, which represent each color component with 8 bits. In such an embodiment, a bitmap 134 is capable of providing indications for a block of 24 pixels—i.e., one bit for each pixel. While transmitting pixels in the manner shown in FIG. 4 may result in a 1-bit penalty for the bit in the bitmap, reduction in the amount of transferred data can be achieved even if at least 5% of the pixels stay the same from one frame to the next. For example, for a 480 KB frame, use of bitmaps 134 may result in an additional 20 KB being transmitted. If, however, only 25% of pixels differ between two frames, this may result in savings of 340 KB for transmitting the subsequent frame.

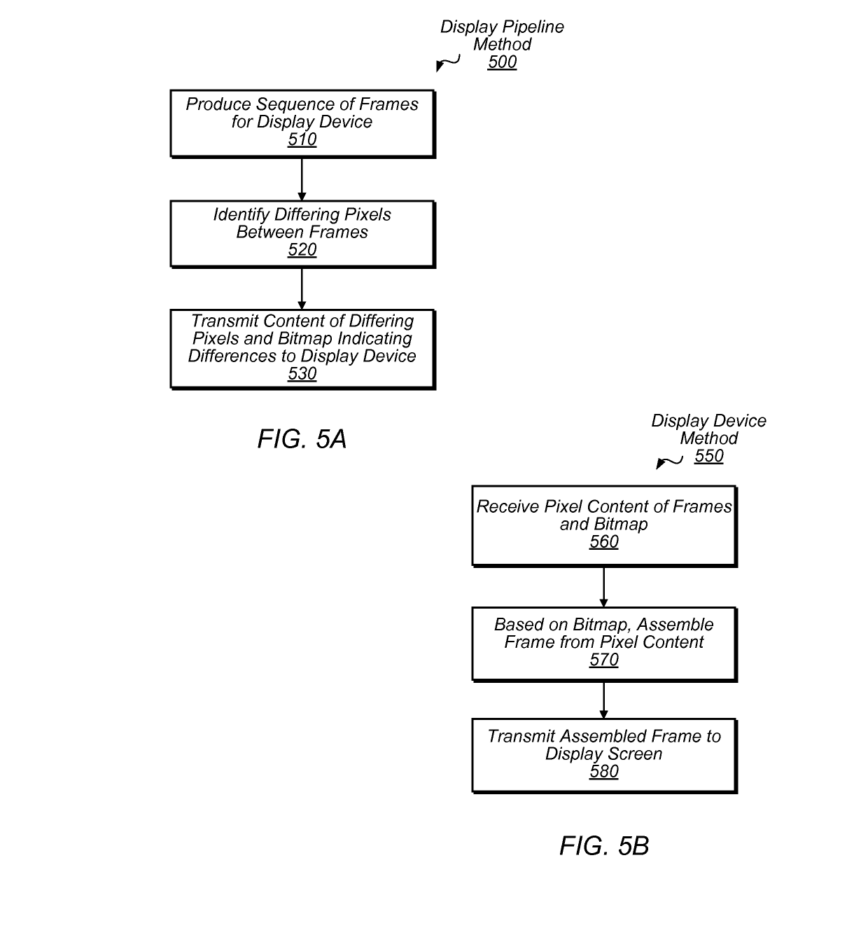

Turning now to FIG. 5A, a flowchart of display pipeline method 500 is shown. Method 500 is one embodiment of a method that may be performed by a display pipeline circuitry such as display pipeline 104. In many instances, performance of method 500 may reduce the amount of pixel data that is communicated to a display and, thus result in less power consumption.

In step 510, display pipeline circuitry (e.g., display pipeline 104) produces a sequence of frames for a display device (e.g., display 106), where the sequence includes at least a first frame and a second frame. In some embodiments, producing this sequence may include passing image data through various stages such as those discussed above with respect to stages 110.

In step 520, the display pipeline circuitry identifies pixels (e.g., pixels 132) of the second frame that differ from pixels of the first frame. In one embodiment, the display pipeline circuitry includes a comparator (e.g., comparator 210) that generates a bitmap by comparing the pixels of the second frame with the pixels of the first frame. In some embodiments, the display pipeline circuitry includes a frame buffer (e.g., frame buffer memory 230) that store pixels of the first frame and provides the stored pixels to the comparator, and includes a memory (e.g., bitmap memory 220) that stores bits of the bitmap that are received from the comparator. In some embodiments, the display pipeline circuitry includes a counter (e.g., counter 240) that stores a value identifying a last pixel transmitted to the display device, and the frame buffer uses of the value to identify which of the stored pixels to provide to the comparator. In some embodiments, the comparator outputs a single bit of the bitmap for each comparison of a pixel of the second frame with a pixel of the first frame.

In step 530, the display pipeline circuitry transmits, to the display device, the identified pixels and a bitmap distinct from the pixels that indicates which pixels of the second frame differ from pixels of the first frame. In some embodiments, the display pipeline circuitry transmits a plurality of bitmaps for the second frame. In one embodiment, the plurality of bitmaps includes a bitmap having the same number of bits as a pixel in the second frame (e.g., as discussed with respect to FIG. 4). In some embodiments, the display pipeline circuitry is configured to transmit the bitmap as an initial pixel in a sequence of pixels that includes the first and second pixels. In some embodiments, the display pipeline circuitry includes a display physical interface (PHY) (e.g., PHY 130) that transmits the identified pixels and the bitmap via a serial interconnect to the display device.

Turning now to FIG. 5B, a flowchart of display device method 500 is shown. Method 550 is one embodiment of a method that may be performed by a display device such as display 106. In many instances, performance of method 550 may reduce the amount of communicated pixel data and, thus, conserve power.

In step 560, a display controller (e.g., controller 140) of the display device receives pixels of a first frame, pixels of a second frame, and a bitmap (e.g., bitmaps 134) identifying pixels of the first frame that are present in the second frame. In one embodiment, the bitmap includes a first bit that indicates that a first pixel is not present in the first frame and a second bit that indicates that a second pixel is present in the first frame. In some embodiments, the display controller receives the bitmap via a display serial interface (DSI) in compliance with a specification of the Mobile Industry Processor Interface (MIPI) Alliance.

In step 570, the display controller assembles, based on the bitmap, the second frame from the received pixels of the second frame and the identified pixels of the first frame. In some embodiments, the display controller assembles the second frame based on a plurality of bitmaps, each associated with a respective portion of the second frame. In one embodiment, each bitmap corresponds to a line of pixels (or a portion of a line) in the second frame.

In step 580, the display controller transmits the assembled second frame (e.g., assembled frame 312) to a screen of the display device.

### Exemplary Computer System

Turning now to FIG. 6, a block diagram illustrating an exemplary embodiment of a computing device 600 is shown. In various embodiments, computing device 600 may correspond to (or implement functionality of) computing device 10 described above. In some embodiments, elements of device 600 may be included within a system on a chip (SOC). In some embodiments, device 600 may be included in a mobile device, which may be battery-powered. Therefore, power consumption by device 600 may be an important design consideration. In the illustrated embodiment, device 600 includes fabric 610, processor complex 620, graphics unit 630, display unit 640, cache/memory controller 650, input/output (I/O) bridge 660.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol and elements coupled to fabric 610 may convert from the single communication protocol to other communication protocols internally. As used herein, the term “coupled to” may indicate one or more connections between elements, and a coupling may include intervening elements. For example, in FIG. 6, graphics unit 630 may be described as “coupled to” a memory through fabric 610 and cache/memory controller 650. In contrast, in the illustrated embodiment of FIG. 6, graphics unit 630 is “directly coupled” to fabric 610 because there are no intervening elements.

In the illustrated embodiment, processor complex 620 includes bus interface unit (BIU) 622, cache 624, and cores 626A and 626B. In various embodiments, processor complex 620 may include various numbers of processors, processor cores and/or caches. For example, processor complex 620 may include 1, 2, or 4 processor cores, or any other suitable number. In one embodiment, cache 624 is a set associative L2 cache. In some embodiments, cores 626A and/or 626B may include internal instruction and/or data caches. In some embodiments, a coherency unit (not shown) in fabric 610, cache 624, or elsewhere in device 600 may be configured to maintain coherency between various caches of device 600. BIU 622 may be configured to manage communication between processor complex 620 and other elements of device 600. Processor cores such as cores 626 may be configured to execute instructions of a particular instruction set architecture (ISA) which may include operating system instructions and user application instructions.

Graphics unit 630 may include one or more processors and/or one or more graphics processing units (GPU's). Graphics unit 630 may receive graphics-oriented instructions, such as OPENGL®, Metal, or DIRECT3D® instructions, for example. Graphics unit 630 may execute specialized GPU instructions or perform other operations based on the received graphics-oriented instructions. Graphics unit 630 may generally be configured to process large blocks of data in parallel and may build images in a frame buffer for output to a display. Graphics unit 630 may include transform, lighting, triangle, and/or rendering engines in one or more graphics processing pipelines. Graphics unit 630 may output pixel information for display images.

Display unit 640 may be configured to read data from a frame buffer and provide a stream of pixel values for display. Display unit 640 may be configured as a display pipeline in some embodiments. Further, display unit 640 may be configured as or configured to read data from, display pipeline 104, and may include controller 140. Additionally, display unit 640 may be configured to blend multiple frames to produce an output frame. Further, display unit 640 may include one or more interfaces (e.g., MIPI® or embedded display port (eDP)) for coupling to a user display (e.g., a touchscreen or an external display).

Cache/memory controller 650 may be configured to manage transfer of data between fabric 610 and one or more caches and/or memories. For example, cache/memory controller 650 may be coupled to an L3 cache, which may in turn be coupled to a system memory. In other embodiments, cache/memory controller 650 may be directly coupled to a memory. In some embodiments, cache/memory controller 650 may include one or more internal caches. Memory coupled to controller 650 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 650 may be any type of non-volatile memory such as NAND flash memory, NOR flash memory, nano RAM (NRAM), magneto-resistive RAM (MRAM), phase change RAM (PRAM), Racetrack memory, Memristor memory, etc.

I/O bridge 660 may include various elements configured to implement: universal serial bus (USB) communications, security, audio, and/or low-power always-on functionality, for example. I/O bridge 660 may also include interfaces such as pulse-width modulation (PWM), general-purpose input/output (GPIO), serial peripheral interface (SPI), and/or inter-integrated circuit (I2C), for example. Various types of peripherals and devices may be coupled to device 600 via I/O bridge 660. For example, these devices may include various types of wireless communication (e.g., wifi, Bluetooth, cellular, global positioning system, etc.), additional storage (e.g., RAM storage, solid state storage, or disk storage), user interface devices (e.g., keyboard, microphones, speakers, etc.), etc.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An integrated circuit, comprising:
a memory; and
display pipeline circuitry coupled to the memory and configured to:
produce a sequence of frames for a display device, wherein the sequence includes a first frame and a second, subsequent frame;
identify pixels of the second frame that differ from pixels of the first frame; and
transmit, to the display device, content of the identified pixels and a bitmap indicating the locations of the identified pixels within the second frame.

2. The integrated circuit of claim 1, wherein the display pipeline circuitry includes:
a comparator circuit configured to generate the bitmap by comparing the pixels of the second frame with the pixels of the first frame.

3. The integrated circuit of claim 2, wherein the display pipeline circuitry includes:
a frame buffer configured to store pixels of the first frame and provide the stored pixels to the comparator circuit; and
a bitmap memory configured to store bits of the bitmap that are received from the comparator.

4. The integrated circuit of claim 3, wherein the display pipeline circuitry includes:
a counter configured to store a value identifying a last pixel having content transmitted to the display device, and wherein the frame buffer is configured to use of the value to identify which of the stored pixels to provide to the comparator.

5. The integrated circuit of claim 2, wherein the comparator circuit is configured to output a single bit of the bitmap for each comparison of a pixel of the second frame with a pixel of the first frame.

6. The integrated circuit of claim 2, wherein the comparator circuit is coupled to an output of a dithering stage of the display pipeline circuitry, wherein the dithering stage is configured to apply dithering operations to the first and second frames.

7. The integrated circuit of claim 1, wherein the display pipeline circuitry is configured to transmit a plurality of bitmaps for the second frame.

8. The integrated circuit of claim 7, wherein the plurality of bitmaps includes a bitmap having the same number of bits as a pixel in the second frame.

9. The integrated circuit of claim 7, wherein the display pipeline circuitry is configured to transmit the bitmap as an initial pixel in a sequence of pixels that includes the first and second pixels.

10. The integrated circuit of claim 1, wherein the display pipeline circuitry includes a display physical interface (PHY) configured to transmit the identified pixels and the bitmap via a serial interconnect to the display device.

11. A computing device, comprising:
a display; and
an integrated circuit coupled to the display and configured to:
create frames to be presented on the display, wherein the frames include a first frame and a subsequent, second frame;
generate, for a set of pixels of in the second frame, a bitmap that identifies whether each pixel in the set is present in the first frame; and
communicate, to the display, the bitmap and pixel content values for the pixels of the set that are identified in the bitmap as not being present in the first frame.

12. The computing device of claim 11, wherein the set of pixels correspond to a line within the frame.

13. The computing device of claim 12, wherein the bitmap includes a respective bit for each pixel in the set, wherein each of the respective bits identifies whether that pixel is present in the first frame.

14. The computing device of claim 11, wherein the number of pixels in the set is the same as the number of bits in a pixel.

15. The computing device of claim 11, wherein the display is configured to:
store pixel content values for pixels of the first frame; and
based on the bitmap, reassemble pixels of the second frame from the communicated pixel content values for pixels of the second frame and the stored pixel content values for pixels of the first frame.

16. A display device, comprising:
a screen; and
a display controller configured to:
receive pixels of a first frame, pixels of a second frame, and a bitmap indicating the pixels of the first frame that are present in the second frame;
based on the bitmap, assemble the second frame from the received pixels of the second frame and the indicated pixels of the first frame; and
transmit the assembled second frame to the screen.

17. The display device of claim 16, wherein the display controller is configured to assemble the second frame based on a plurality of bitmaps, each of which is associated with a respective portion of the second frame.

18. The display device of claim 17, wherein the received bitmap corresponds to a line of pixels in the second frame.

19. The display device of claim 16, wherein the bitmap includes a first bit that indicates that a first pixel is not present in the first frame and a second bit that indicates that a second pixel is present in the first frame.

20. The display device of claim 16, wherein the display controller is configured to receive the bitmap via a display serial interface (DSI) in compliance with a specification of the Mobile Industry Processor Interface (MIPI) Alliance.
